(19) United States
(12) Patent Application Publication
(10) Pub. No.: US 2004/0073427 A1
(43) Pub. Date: Apr. 15, 2004

(54) Speech synthesis apparatus and method

(75) Inventor: Roger Kenneth Moore, West Malvern (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: 20/20 Speech Limited, London (GB)

(21) Appl. No.: 10/645,677

(22) Filed: Aug. 20, 2003

(30) Foreign Application Priority Data
Aug. 27, 2002 (GB) GB 0219870.3

(51) Int. Cl. G10L 13/00

(52) U.S. Cl. 704/258

(57) ABSTRACT

A speech synthesizer and a method for synthesizing speech are disclosed. The synthesizer has an output stage for converting a phonetic description to an acoustic output. The output stage includes a database of recorded utterance segments. The output stage operates: a. to convert the phonetic description to a plurality of time-varying parameters; and b. to interpret the parameters as a key for accessing the database to identify an utterance segment in the database. The output stage then outputs the identified utterance segment. The output stage further comprises an output waveform synthesizer that can generate an output signal from the parameters. Therefore, in the event that the parameters describe an utterance segment for which there is no corresponding recording in the database, the parameters are passed to the output waveform synthesizer to generate an output signal.

### BACKGROUND TO TILE INVENTION

1. Field of the Invention

This invention relates to a speech synthesis apparatus and method.

The basic principle of speech synthesis is that incoming text is converted into spoken acoustic output by the application of various stages of linguistic and phonetic analysis. The quality of the resulting speech is dependent on the exact implementation details of each stage of processing, and the controls that are provided to the application programmer for controlling the synthesizer.

2. Summary of the Prior Art

The final stage in a typical text-to-speech engine converts a detailed phonetic description into acoustic output. This stage is the main area where different known speech synthesis systems employ significantly different approaches. The majority of contemporary text-to-speech synthesis systems have abandoned traditional techniques based on explicit models of a typical human vocal tract in favor of concatenating waveform fragments selected from studio recordings of an actual human talker. Context-dependent variation is captured by creating a large inventory of such fragments from a sizeable corpus of carefully recorded and annotated speech material. Such systems will be described in this specification as “concatenative”.

The advantage of the concatenative approach is that, since it uses actual recordings, it is possible to create very natural-sounding output, particularly for short utterances with few joins. However, the need to compile a large database of voice segments restricts the flexibility of such systems. Vendors typically charge a considerable amount to configure a system for a new customer-defined voice talent, and the process to create such a bespoke system can take several months. In addition, by necessity, such systems require a large memory resource (typically, 64-512 Mbytes per voice) in order to store as many fragments of speech as possible, and require significant processing power (typically 300-1000 MIPS) to perform the required search and concatenation.

For these reasons, concatenative TTS systems typically have a limited inventory of voices and voice characteristics. It is also the case that the intelligibility of the output of a concatenative system can suffer when a relatively large number of segments must be joined to form an utterance, or when a required segment is not available in the database. Nevertheless, due to the natural sound of their output speech, such synthesizers are beginning to find application where significant computing power is available.

A minority of contemporary text-to-speech synthesis systems continue to use a traditional formant-based approach that uses an explicit computational model of the resonances—formants—of the human vocal tract. The output signal is described by several periodically generated parameters, each of which typically represents one formant, and an audio generation stage is provided to generate an audio output signal from the changing parameters. (These systems will be described as “parametric”.) This scheme avoids the use of recorded speech data by using manually derived rules to drive the speech generation process. A consequent advantage of this approach is that it provides a very small footprint solution (1-5 Mbytes) with moderate processor requirements (30-50 MNPS). These systems are therefore used when limited computing power rules out the use of a concatenative system. However, the downside is that the naturalness of the output speech is usually rather poor in comparison with the concatenative approach, and formant synthesizers arc often described as having a ‘robotic’ voice quality, although this need not adversely affect the intelligibility of the synthesized speech.

### SUMMARY OF THE INVENTION

An aim of this invention is to provide a speech synthesis system that provides the natural sound of a concatenative system and the flexibility of a formant system.

From a first aspect, this invention provides a speech synthesizer having an output stage for converting a phonetic description to an acoustic output, the output stage including a database of recorded utterance segments, in which the output stage:

a. converts the phonetic description to a plurality of time-varying parameters;

b. interprets the parameters as a key for accessing the database to identify an utterance segment in the database, and

c. outputs the identified utterance segment;

in which the output stage further comprises an output waveform synthesizer that can generate an output signal from the parameters, whereby, in the event that the parameters describe an utterance segment for which there is no corresponding recording in the database, the parameters are passed to the output waveform synthesizer to generate an output signal.

Thus, the parameters that are typically used to cause an output waveform to be generated and output instead cause a prerecorded waveform to be selected and output. The parameters describe just a short segment of speech, so each segment stored in the database is small, so the database itself is small when compared with the database of a concatenative system. However, the database contains actual recorded utterances, which, the inventors have found, retain their natural sound when reproduced in a system embodying the invention. The synthesizer may operate in a concatenative mode where possible, and fall back to a parametric mode, as required.

Such an output waveform synthesizer may be essentially the same as the parallel formant synthesizer used in a conventional parametric synthesis system.

In a synthesizer according to the last-preceding paragraph, the database can be populated to achieve an optimal compromise between memory requirements and perceived output quality. In the case of a synthesizer that is intended to generate arbitrary output, the larger the database, the greater the likelihood of operation in the concatenative mode. In the case of a synthesizer that is intended to be used predominantly or entirely to generate a restricted output repertoire, the database may be populated with segments that are most likely to be required to generate the output. For example, the database may be populated with utterance segments derived from speech by a particular individual speaker, by speakers of a particular gender, accent, and so forth. Of course, this restricts the range of output that will be generated in concatenative mode, but offers a reduction in the size of the database. However, it does not restrict the total output range of the synthesizer, which can always operate in parametric mode when required. It will be seen that selection of an appropriate database allows the implementation of an essentially continuous range of synthesizers that achieve a compromise between quality and memory requirement most appropriate to a specific application.

In order that the database can be accessed quickly, it is advantageously an indexed database. In that case, the index values for accessing the database may be the values of the time-varying parameters. Thus, the same values can be used to generate an output whether the synthesizer is operating in a concatenative mode or in a parametric mode.

The segments within the database may be coded, for example using linear predictive coding, GSM coding or other coding schemes. Such coding offers a system implementer further opportunity to achieve a compromise between the size of the database and the quality of the output.

In a typical synthesizer embodying the invention, the parameters are generated in regular periodic frames, for example, with a period of several ms—more specifically, in the range 2 to 30 ms. For example, a period of approximately 10 ms may be suitable. In typical embodiments, there are ten parameters. The parameters may correspond to or be related to speech formants. At each frame, an output waveform is generated, either from a recoding obtained from the database or by synthesis, these being reproduced in succession to create an impression of a continuous output.

From a second aspect, this invention provides a method of synthesizing speech comprising:

a. generating from a phonetic description a plurality of time-varying parameters that describe an output waveform;

b. interpreting the parameters to identify an utterance segment within a database of such segments that corresponds to the audio output defined by the parameters and retrieving the segment to create an output waveform; and

c. outputting the output waveform;

in which, if no utterance segment is identified in the database in step b, as corresponding to the parameters, an output waveform for output in step c is generated by synthesis.

In a method embodying this aspect of the invention, if no utterance segment is identified in the database in step b, as corresponding to the parameters, an output waveform for output in step c is generated by synthesis.

Steps a to c are repeated in quick succession to crate an impression of a continuous output. Typically, the parameters arc generated in discrete frames, and steps a to c are performed once for each frame. The frames may be generated with a regular periodicity, for example, with a period of several ms—such as in the range 2 to 30 ms (e.g. 10 ms or thereabouts). The parameters within the frames typically correspond to or relate to speech formants.

In order to improve the perceived quality of output speech, it may be desirable not only to identify instantaneous values for the parameters, but also to take into account trends in the change of the parameters. For example, if several of the parameters are rising in value over several periods, it may not be appropriate to select an utterance segment that originated from a section of speech in which these parameter values were falling. Therefore, the output segment for any one frame may be selected as a function of the parameters of several frames. For example, the parameters of several surrounding frames may be analyzed in order to create a set of indices for the database. While this may improve output quality, it is likely to increase the size of the database because there may be more than one utterance segment corresponding to any one set of parameter values. Once again, this can be used by an implementer as a further compromise between output quality and database size.

### BRIEF DESCRIPTION OF THE DRAWINGS

In the drawings:

FIG. 1 is a functional block diagram of a text-to-speech system embodying the invention;

FIG. 2 is a block diagram of components of a text-to-speech system embodying the invention; and

FIG. 3 is a block diagram of a waveform generation stage of the system of FIG. 2.

### DETAILED DESCRIPTION OF THE PREFERRED EMBODIMENTS

An embodiment of the invention will now be described in detail, by way of example, and with reference to the accompanying drawings.

Embodiments of the invention will be described with reference to a parameter-driven text-to-speech (TTS) system. However, the invention might be embodied in other types of system, for example, including speech synthesis systems that generate speech from concepts, with no source text.

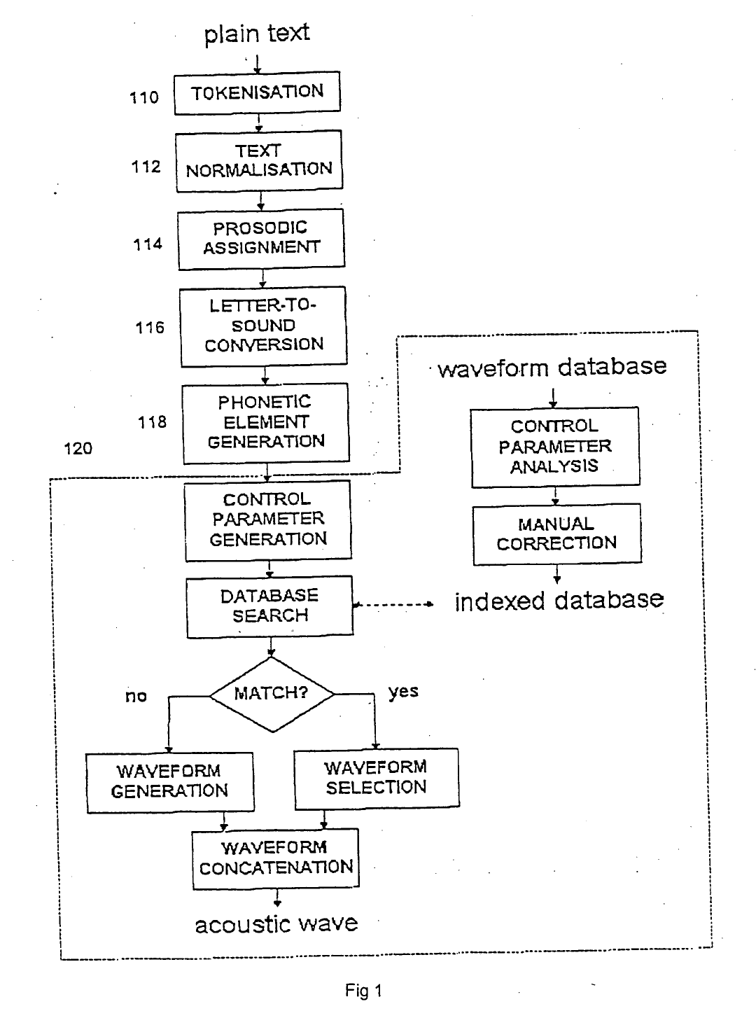

The basic principle of operation of a TTS engine will be described with reference to FIG. 1. The engine takes an input text and generates an audio output waveform that can be reproduced to generate an audio output that can be comprehended by a human as speech that, effectively, is a reading of the input text. Note that these are typical steps. A particular implementation of a TTS engine may omit one or more of them, apply variations to them, and/or include additional steps.

The incoming text is converted into spoken acoustic output by the application of various stages of linguistic and phonetic analysis. The quality of the resulting speech is dependent on the exact implementation details of each stage of processing, and the controls that the TTS engine provides to an application programmer.

Practical TTS engines are interfaced to a calling application through a defined application program interface (APT). A commercial TTS engine will often provide compliance with the Microsoft (r. t. m.) SAP1 standard, as well as the engine's own native API (that may offer greater functionality). The API provides access to the relevant function calls to control operation of the engine.

As a first step in the synthesis process the input text may be marked up in various ways in order give the calling application more control over the synthesis process (Step 110).

At present, several different mark-up conventions are currently in use, including SABLE, SAPI, VoiceXML and JSML, and most are subject to approval by W3C. These languages have much in common, both in terms of their structure and of the type of information they encode. However, many of the markup languages are specified in draft form only, and are subject to change. Presently, the most widely accepted TTS mark-up standards are defined by Microsoft's SAPI and VoiceXML, but the “Speech Application Language Tags” has been commenced to provide a non-proprietary and platform-independent alternative.

As an indication of the purpose of mark-up handling, the following list outlines typical mark-up elements that are concerned with aspects of the speech output:

Document identifier: identifies the XML used to mark up a region of text;

Text insertion, deletion and substitution: indicates if a section of text should be inserted or replaced by another section;

Emphasis: alters parameters related to the perception of characteristics such as sentence stress, pitch accents, intensity and duration;

Prosodic break: forces a prosodic break at a specified point in the utterance;

Pitch: alters the fundamental frequency for the enclosed text;

Rate: alters the durational characteristics for the enclosed text;

Volume: alters the intensity for the enclosed text;

Play audio: indicates that an audio file should be played at a given point in the stream;

Bookmark: allows an engine to report back to the calling application when it reaches a specified location;

Pronunciation: controls the way in which words corresponding to the enclosed tokens are pronounced;

Normalization: specifies what sort of text normalization rules should be applied to the enclosed text;

Language: identifies the natural language of the enclosed text

Voice: specifies the voice ID to be used for the enclosed text;

Paragraph: indicates that the enclosed text should be parsed as a single paragraph;

Sentence: indicates that the enclosed text should be parsed as a single sentence;

Part of speech: specifies that the enclosed token or tokens have a particular part of speech (POS);

Silence: produces silence in the output audio stream.

The text normalization (or pre-processing) stage (112) is responsible for handling the special characteristics of text that arise from different application domains, and for resolving the more general ambiguities that occur in interpreting text. For example, it is the text normalization process that has to use the linguistic context of a sentence to decide whether ‘1234’ should be spoken as “one two three four” or “one thousand two hundred and thirty four”, or whether ‘Dr.’ should be pronounced as “doctor” or “drive”.

Some implementations have a text pre-processor optimized for a specific application domain (such as e-mail reading), while others may offer a range of preprocessors covering several different domains. Clearly, a text normalizer that is not adequately matched to an application domain is likely to cause the TTS engine to provide inappropriate spoken output.

The prosodic assignment component of a TTS engine performs linguistic analysis of the incoming text in order to determine an appropriate intonational structure (the up and down movement of voice pitch) for the output speech, and the timing of different parts of a sentence (step 114). The effectiveness of this component contributes greatly to the quality and intelligibility of the output speech.

The actual pronunciation of each word in a text is determined by a process (step 116) known as ‘letter-to-sound’ (LTS) conversion. Typically, this involves looking each word up in a pronouncing dictionary containing the phonetic transcriptions of a large set of words (perhaps more than 100 000 words), and employing a method for estimating the pronunciation of words that might not be found in the dictionary. Often TTS engines offer a facility to handle multiple dictionaries; this can be used by system developers to manage different application domains. The LTS process also defines the accent of the output speech.

In order to model the co-articulation between one sound and another, the phonetic pronunciation of a sentence is mapped into a more detailed sequence of context-dependent allophonic units (Step 118) It is this process that can model the pronunciation, habits of an, individual speaker, and thereby provide some ‘individuality’ to the output speech.

As will be understood from the description above, the embodiment shares features with a large number of known TTS systems. The final stage (Step 120) in a TTS engine converts the detailed phonetic description into acoustic output, and is here that the embodiment differs from known systems. In embodiments of the invention, a control parameter stream is created from the phonetic description to drive a waveform generation stage that generates an audio output signal. There is a correspondence between the control parameters and vocal formants.

The waveform generation stage of this embodiment includes two separate subsystems, each of which is capable of generating an Output waveform defined by the control parameters, as will be described in detail below. A first subsystem, referred to as the “concatenative mode subsystem”, includes a database of utterance segments, each derived from recordings of one or more actual human speakers. The output waveform is generated by selecting and outputting one of these segments, the parameters being used to determine which segment is to be selected A second subsystem, referred to as the “parameter mode subsystem” includes a parallel formant synthesizer, as is found in the output stage of a conventional parameter-driven synthesizer. In operation, for each parameter frame, the waveform generations stage first attempts to locate an utterance segment in the database that best matches (according to some threshold criterion) the parameter values. If this is found, it is output. If it is not found, the parameters are passed to the parameter mode subsystem which synthesizes an output from the parameter values, as is normal for a parameter driven synthesizer.

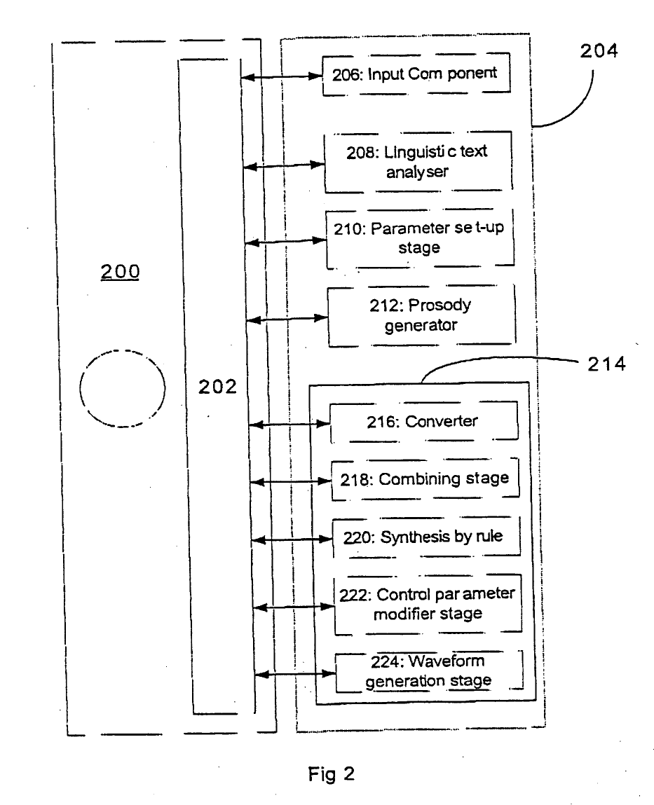

The structure of the TTS system embodying the invention will now be described with reference to FIG. 2. Such a system may be used in, implementations of embodiments of the invention. Since this architecture will be familiar to workers in this technical field, it will be described only briefly.

Analysis and synthesis processes of TTS conversion involve a number of processing. In this embodiment, these different operations arc performed within a modular architecture in which several modules 204 are assigned to handle the various tasks. These modules are grouped logically into an input component 206, a linguistic text analyzer 208 (that will typically include several nodules), a voice characterization parameter set-up stage 210 for setting up voice characteristic parameters, a prosody generator 212, and a speech sound generation group 214 that includes sever modules, these being a converter 216 from phonemes to context-dependent PEs, a combining stage 218 for combining PEs with prosody, a synthesis-by-rule module 220, a control parameter modifier stage 222, and an output stage 224. An output waveform is obtained from the output stage 124.

In general, when text is input to the system, each of the modules takes some input related to the text, which may need to be generated by other modules in the system, and generates some output, which can then be used by further modules, until the final synthetic speech waveform is generated.

All information within the system passes from one module to another via a separate processing engine 200 through an interface 202; the modules 204 do not communicate directly with each other, but rather exchange data bi-directionally with the processing engine 200. The processing engine 200 controls the sequence of operations to be performed, stores all the information in a suitable data structure and deals with the interfaces required to the individual modules. A major advantage of this type of architecture is the ease with which individual modules can be changed or new modules added. The only changes that are required are in the accessing of the modules 204 in the processing engine; the operation of the individual modules is not affected in addition, data required by the system (such as a pronouncing dictionary 205EI to specify how words are to be pronounced) tends to be separated from the processing operations that act on the data. This structure has the advantage that it is relatively straightforward to tailor a general system to a specific application or to a particular accent, to a new language, or to implement the various aspects of the present invention.

The parameter set-up stage 210, includes voice characteristic parameter tables that define the characteristics of one or more different output voices. These may be derived from the voices of actual human speakers, or they may bc essentially synthetic, having characteristics to suit a particular application. A particular output voice characteristic can be produced in two distinct modes. First, the voice characteristic can be one of those defined by the parameter tables of the voice characteristic parameter set-up stage 210. Second, a voice characteristic can be derived as a combination of two or more of those defined in the voice characteristic parameter set-up stage. The control parameter modifier stage 222 serves further to modify the voice characteristic parameters, and thereby further modify the characteristics of the synthesized voice. This allows speaker-specific configuration of the synthesis system. These stages permit characterization of the output of the synthesizer to produce various synthetic voices, particularly deriving for each synthetic voice an individual set of tables for use in generating an utterance according to requirements specified at the input. Typically, the voice characteristic parameter set-up stage 210 includes multiple sets of voice characteristic tables, each representative of the characteristics of an actual recorded voice or of a synthetic voice.

As discussed, voice characteristic parameter tables can be generated from an actual human speaker. The aim is to derive values for the voice characteristic parameters in a set of speaker characterization tables which, when used to generate synthetic speech, produce as close a match as possible, to a representative database of speech from a particular talker. In a method for generating the voice characterization parameters, the voice characteristic parameter tables are optimized to match natural speech data that has been analyzed in terms of synthesizer control parameters. The optimization can use a simple grid-based search, with a predetermined set of context-dependent allophone units. There are various known methods and systems that can generate such tables, and these will not be described further in this specification.

Each voice characteristic parameter table that corresponds to a particular voice comprises a set of numeric data.

The parallel-formant synthesizer as illustrated in FIG. 2 has twelve basic control parameters. Those parameters are as follows:

TABLE 1

| Designation | Description |
|---|---|
| F0 | Fundamental frequency |
| FN | Nasal frequency |
| F1, F2, F3 | The first three formant frequencies |
| ALF, AL1 . . . AL4 | Amplitude controls |
| | Degree of voicing |
| | Glottal pulse open/closed ratio |

These control parameters are created in a stream of frames with regular periodicity, typically at a frame interval of 10 ms or less. To simplify operation of the synthesizer, some control parameters may be restricted. For example, the nasal frequency FN may be fixed at, say, 250 Hz and the glottal pulse open/closed ratio is fixed at 1:1. This means that only ten parameters need be specified for each time interval.

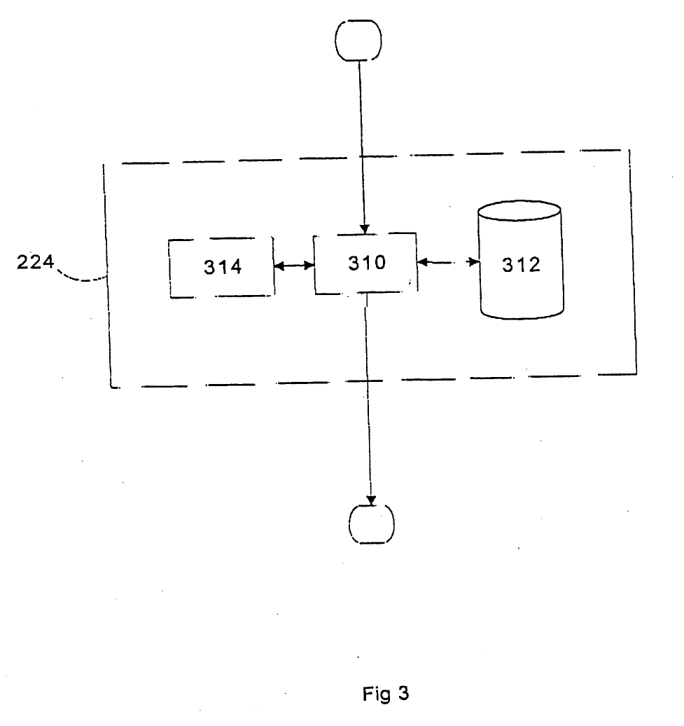

Each frame of parameters is converted to an output waveform by a waveform generation stage 224. As shown in FIG. 3, the waveform generation stage has a processor 310 (which may be a virtual processor, being a process executing on a microprocessor). At each frame, the processor receives a frame of control parameters on its input. The processor calculates a database key from the parameters and applies the key to query a database 312 of utterance segments.

The query can have two results. First, it may be successful. In this event, an utterance segment is returned to the processor 310 from the database 312. The utterance segment is then output by the processor, after suitable processing, to form the output waveform for the present frame. This is the synthesizer operating in concatenative mode. Second, the query may be unsuccessful. This indicates that there is no utterance segment that matches (exactly or within a predetermined degree of approximation) the index value that was calculated from the keys. The processor then passes the parameters to a parallel formant synthesizer 314. The synthesizer 314 generates an output waveform as specified by the parameters, and this is returned to the processor to be processed and output as the output waveform for the present claim. This is the synthesizer operating in parametric mode. Alternatively, the query may first be reformulated in an attempt to make an approximate match with a segment. In such cases, it may be that one or more of the parameters is weighted to ensure that it is matched closely, while other parameters may be matched less strictly.

To generate an output that is perceived as continuous, successive output waveforms are concatenated. Procedures for carrying out such concatenation are well known to those skilled in the technical field. One such technique that could be applied in embodiments of this invention is known as “pitch-synchronous overlap and add” (PSOLA). This is fully described in Speech Synthesis and Recognition, John Holmes and Wendy Holmes, 2nd edition, pp 74-80, §5.4 onward. However, the inventors have found that any such concatenation technique must be applied with care in order that the regular periodicity of the segments does not lead to the formation of unwanted noise in the output.

In order to populate the database, recorded human speech is segmented to generate waveform segments of duration equal to the periodicity of the parameter frames. At the same time, the recorded speech is analyzed to calculate a parameter frame that corresponds to the utterance segment.

The recordings are digitally sampled (e.g. 16-bit samples at 22 k samples per second).

They are then analyzed (initially automatically by a formant analyzer and then by optional manual inspection/correction) to produce an accurate parametric description at e.g. a 10 msec frame-rate. Each frame is thus annotated with (and thus can be indexed by) a set of (e.g. ten) parameter values. A frame corresponds to a segment of waveform (e.g. one 10 msec frame=220 samples). During operation of the synthesizer, the same formant values are derived from frames of the parameter stream to serve as indices that can be used to retrieve utterance segments from the database efficiently.

If it is required to further compress the database at the expense of some loss of quality, the speech, segments may be coded. For example, known coding systems such as linear predictive coding, GSM, and so forth may be used. In such embodiments, the coded speech segments would need to be concatenated using methods appropriate to coded segments.

In a modification to the above embodiment, a set of frames can be analyzed in the process of selection of a segment from the database. The database lookup can be done using a single frame, or by using a set of (e.g. 3, 5 etc.) frames. For instance, trends in the change of value of the parameters of the various frames can be identified, with the most weight being given to the parameters of the central frame. As one example, there may be two utterance segments in the database that correspond to one set of parameter values, one of the utterance segments being selected if the trend shows that the value of F2 is increasing and the other being selected if the value of F2 is decreasing.

The advantage of using a wider window (more frames) is that the quality of resulting match for the central target frame is likely to be improved. A disadvantage is that it may increase the size of the database required to support a given overall voice quality. As with selection of the database content described above, this can be used to optimize the system by offsetting database size against output quality.

What is claimed is:

1. A speech synthesizer having an output stage for converting a phonetic description to an acoustic output, the output stage including a database of recorded utterance segments, in which the output stage:
a. converts the phonetic description to a plurality of time-varying parameters;
b. interprets the parameters as a key for accessing the database to identify an utterance segment in the database, and
c. outputs the identified utterance segment;
in which the output stage further comprises an output waveform synthesizer that can generate an output signal from the parameters, whereby, in the event that the parameters describe an utterance segment for which there is no corresponding recording in the database, the parameters are passed to the output waveform synthesizer to generate an output signal.

2. A speech synthesizer according to claim 1 in which the output waveform synthesizer is essentially the same as the synthesizer used in a conventional parametric synthesizer.

3. A speech synthesizer according to claim 1 in which the database is populated to achieve a compromise between quality and memory requirement most appropriate to a specific application.

4. A speech synthesizer according to claim 3 in which the database is populated with segments that are most likely to be required to generate a range of output corresponding to the application of the synthesizer.

5. A speech synthesizer according to claim 4 in which the database is populated with utterance segments derived from speech by a particular individual speaker.

6. A speech synthesizer according to claim 4 in which the database is populated with utterance segments derived from speech by speakers of a particular gender.

7. A speech synthesizer according to claim 4 in which the database is populated with utterance segments derived from speech by speakers having a particular accent.

8. A speech synthesizer according to claim 1 in which the database is an indexed database.

9. A speech synthesizer according to claim 8 in which the index values for accessing the database are the values of the time-varying parameters.

10. A speech synthesizer according to claim 1 in which the segments within the database are coded.

11. A speech synthesizer according to claim 10 in which the segments within the database are coded using linear predictive coding, GSM coding or other coding schemes.

12. A speech synthesizer according to claim 1 in which the parameters are generated in regular periodic frames.

13. A speech synthesizer according to claim 12 in which the frames have a period of 2 to 30 ms.

14. A speech synthesizer according to claim 13 in which the period is approximately 10 ms.

15. A speech synthesizer according to claim 13 in which at each frame, an output waveform is generated these being reproduced in succession to create an impression of a continuous output.

16. A speech synthesizer according to claim 1 in which the parameters correspond to speech formants.

17. A method of synthesizing speech comprising:
a. generating from a phonetic description a plurality of time-varying parameters that describe an output waveform;
b. interpreting the parameters to identify an utterance segment within a database of such segments that corresponds to the audio output defined by the parameters and retrieving the segment to create an output waveform; and
c. outputting the output waveform;
in which, if no utterance segment is identified in the database in step b, as corresponding to thc parameters, an output waveform for output in step c is generated by synthesis.

18. A method of synthesizing speech according to claim 17 in which steps a to c are repeated in quick succession to create an impression of a continuous output.

19. A method of synthesizing speech according to claim 17 in which the parameters are generated in discrete frames, and steps a to c arc performed once for each frame.

20. A method of synthesizing speech according to claim 17 in which the frames are generated with a regular periodicity.

21. A method of synthesizing speech according to claim 20 in which the frames are generated with a period of several ms (e.g. 10 ms or thereabouts).

22. A method of synthesizing speech according to claim 17 in which the parameters within the frames correspond to speech formants.

23. A method of synthesizing speech according to claims 17 in which the output segments for any one frame are selected as a function of the parameters of several frames.
